(19) United States
(12) Patent Application Publication
(10) Pub. No.: US 2006/0158389 A1
(43) Pub. Date: Jul. 20, 2006

(54) PLASMA DISPLAY APPARATUS AND DRIVING METHOD THEREOF

(75) Inventor: Seong Hak MOON, Guro-gu (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,543

(22) Filed: Jan. 13, 2006

(30) Foreign Application Priority Data
Jan. 18, 2005 (KR) 10-2005-0004747

(51) Int. Cl. G09G 3/28

(52) U.S. Cl. 345/67

(57) ABSTRACT

The present invention relates to a display apparatus, and more particularly, to a plasma display apparatus and driving method thereof. The plasma display apparatus according to an aspect of the present invention comprises a plasma display-panel in which images are represented with each of a plurality of sub-fields being divided into a reset period, an address period and a sustain period, a set-up controller for controlling an amplitude of a set-up pulse applied to a scan electrode during the reset period according to an APL value of an externally input image signal, and a set-up supply unit for supplying an amplitude of the controlled set-up pulse to the scan electrode.

### CROSS-REFERENCE TO RELATED APPLICATIONS

This Nonprovisional application claims priority under 35 U.S.C. § 119(a) on Patent Application No.10-2005-0004747 filed in Korea on Jan. 18, 2005 the entire contents of which are hereby incorporated by reference.

### BACKGROUND OF THE INVENTION

1. Field of the Invention

The present invention relates to a display apparatus, and more particularly, to a plasma display apparatus and a driving method thereof.

2. Background of the Related Art

In general, a conventional plasma display apparatus has a plasma display panel and drivers. The plasma display apparatus displays images including characters and/or graphics by light-emitting phosphors with ultraviolet rays of 147 nm generated during the discharge of a mixed inert gas such as He+Xe or Ne+Xe.

FIG. 1 illustrates the construction of a plasma display panel in the related art.

As shown in FIG. 1, the plasma display panel comprises a front panel 100 in which a plurality of sustain electrode pairs in which scan electrodes 102 and sustain electrodes 103 are formed in pairs is arranged, and a rear panel 110 in which a plurality of address electrodes 113 crossing the plurality of sustain electrode pairs is arranged. The front panel 100 and the rear panel 110 are attached in parallel with a predetermined distance therebetween.

In the front panel 100, the scan electrodes 102 and the sustain electrodes 103 are formed on a front glass 101 in order to mutually discharge one another and sustain the emission of a cell within one discharge cell. Each of the scan electrodes and the sustain electrode has a transparent electrode (a) formed of a transparent material and a bus electrode (b) formed of a metal material such as silver (Ag). The scan electrodes 102 and the sustain electrodes 103 are covered with a dielectric layer 104 that limits a discharge current and provides insulation among the electrode pairs. A protection layer 105 having deposited Magnesium Oxide (MgO) thereon is formed on the dielectric layer 104 to facilitate discharge conditions.

In the rear panel 110, address electrodes 112 are formed on a rear glass 11 so that data can be written through a write discharge with the scan electrodes 102. The address electrodes 112 are covered with a lower dielectric layer 115 so that a discharge current can be limited. Barrier ribs 112 of a stripe type, for forming a plurality of discharge cells, are arranged in parallel on the lower dielectric layer 115. R, G and B phosphor 114 that radiates a visible ray for displaying images during a discharge is coated on a top surface of the lower dielectric layer 115 and between the barrier ribs 114.

A method of representing gray levels of an image by driving the plasma display panel constructed above will now be described with reference to FIG. 2.

FIG. 2 illustrates a method of implementing gray levels of an image in the plasma display panel in the related art. As shown in FIG. 2, to represent image gray levels of the plasma display panel in the related art, one frame is divided into several sub-fields having a different number of emissions. Each of the sub-fields is divided into a reset period (RPD) for initializing the entire cells, an address period (APD) for selecting a cell to be discharged, and a sustain period (SPD) for implementing gray levels depending on the number of discharges. For example, to display images with 256 gray levels, a frame period (16.67-ms) corresponding to 1/60 seconds is divided into eight sub-fields (SF1 to SF8) as shown in FIG. 2. Each of the eight sub-fields (SF1 to SF8) is again divided into a reset period, an address period and a sustain period.

The reset period and the address period of each sub-field are the same every sub-field. An address discharge for selecting a cell to be discharged is generated because of a voltage difference between the address electrodes and the scan electrodes (i.e., transparent electrodes). The sustain period is increased in the ratio of 2ⁿ (where n=0,1,2,3,4,5,6,7) in each sub-field. Since the sustain period varies for every sub-field as described above, gray levels of an image are represented by controlling the sustain period of each sub-field, i.e., a sustain discharge number. A driving voltage depending on the method of driving the plasma display panel will be described below with reference to FIG. 3.

FIG. 3 shows a driving waveform depending on the driving method of the plasma display panel in the related art.

As shown in FIG. 3, the plasma display panel is driven with it being divided into a reset period for initializing the entire cells, an address period for selecting cells to be discharged, and a sustain period for sustaining the discharge of selected cells.

In a set-up period of the reset period, a ramp-up voltage is applied to all of the scan electrodes at the same time. The ramp-up voltage generates a weak dark discharge within the discharge cells of the entire screen. The set-up discharge also causes positive wall charges to be accumulated on the address electrodes and the sustain electrodes and negative wall charges to be accumulated on the scan electrodes.

In a set-down period of the reset period, after the ramp-up voltage is applied, a ramp-down voltage, which falls from a positive voltage that is less than a peak voltage of the ramp-up voltage to a predetermined voltage level that is less than a ground (GND) level voltage, generates a weak erase discharge within the cells, so that wall charges excessively formed on the scan electrodes are sufficiently erased.

The set-down discharge causes wall charges of the degree in which an address discharge can be stably generated to uniformly remain within the cells.

In the address period, while negative scan signals are sequentially applied to the scan electrodes, a positive data signal is applied to the address electrodes in synchronization with the scan signal. As a voltage difference between the scan signal and the data signal and a wall voltage generated in the reset period are added together, an address discharge is generated within discharge cells to which the data signal is applied. Wall charges of the degree in which a discharge can be generated when a sustain voltage (Vs) is applied are formed within cells selected by the address discharge. During the set-down period and the address period, the sustain electrodes are supplied with a positive voltage (Vzb) such that an erroneous discharge is not generated between the sustain electrodes and the scan electrodes by reducing a voltage difference between the sustain electrodes and the scan electrodes.

In the sustain period, a sustain signal is alternately applied to the scan electrodes and the sustain electrodes. As a wall voltage within the cells and the sustain signal are added together, a sustain discharge, i.e., a display discharge is generated between the scan electrodes and the sustain electrodes in the cells selected by the address discharge whenever the sustain signal is applied.

The above-described process completes the driving process of the plasma display panel in one sub-field.

When considering an accurate discharge mechanism of the plasma display panel, however the driving process of the plasma display panel in one sub-field has several problems. More particularly, problems in the reset period are as follows.

When driving the plasma display panel, the reset pulse applied to the scan electrodes in the reset period has a fixed amplitude of a reset voltage regardless of an Average Picture Level (APL) depending on an externally input image signal.

The fixed amplitude of the reset pulse voltage is the same regardless of the APL depending on an externally input image signal. Therefore, an excessive dark discharge is generated in one sub-field that does not need a voltage of a high reset pulse. As a result, it serves as an important factor in degrading a contrast ratio characteristic of the plasma display panel.

### SUMMARY OF THE INVENTION

Accordingly, an object of the present invention is to solve at least the problems and disadvantages of the background art.

It is an object of the present invention to provide a plasma display apparatus and driving method thereof, in which driving efficiency and a contrast characteristic can be improved at the same time when driving a plasma display panel.

A plasma display apparatus according to an aspect of the present invention comprises a plasma display panel in which images are represented with each of a plurality of sub-fields being divided into a reset period, an address period and a sustain period, a set-up controller for controlling an amplitude of a set-up pulse applied to a scan electrode during the reset period according to an APL value of an externally input image signal, and a set-up supply unit for supplying an amplitude of the controlled set-up pulse to the scan electrode.

A plasma display apparatus according to another aspect of the present invention comprises a plasma display panel in which images are represented with each of a plurality of sub-fields being divided into a reset period, an address period and a sustain period, and a set-up controller for controlling a slope of a set-up pulse applied to a scan electrode during the reset period according to an APL value of an externally input image signal.

In a method of driving a plasma display apparatus according to further another aspect of the present invention, an amplitude of a set-up pulse applied to a scan electrode during a reset period is controlled according to an APL value of an externally input image signal.

In accordance with the present invention, when driving a plasma display panel, an amplitude or slope of a set-up pulse is controlled. Therefore, driving efficiency is enhanced.

When driving a plasma display panel, an amplitude or slope of a set-up pulse is controlled according to an APL. It is thus possible to improve a contrast characteristic.

### BRIEF DESCRIPTION OF THE DRAWINGS

The invention will be described in detail with reference to the following drawings in which like numerals refer to like elements.

FIG. 1 is a perspective view illustrating the construction of a three-electrode AC surface discharge type plasma display panel in the related art;

FIG. 2 illustrates a method of implementing gray levels of an image of a plasma display panel in the related art;

FIG. 3 shows a driving waveform depending on the method of driving the plasma display panel in the related art;

FIG. 4 is a block diagram of a plasma display apparatus according to the present invention;

FIG. 5 is a circuit diagram illustrating the scan driver of the plasma display apparatus according to the present invention; and

FIGS. 6a and 6b illustrate a set-up pulse supplied during the reset period by means of the scan driver of the plasma display apparatus according to the present invention.

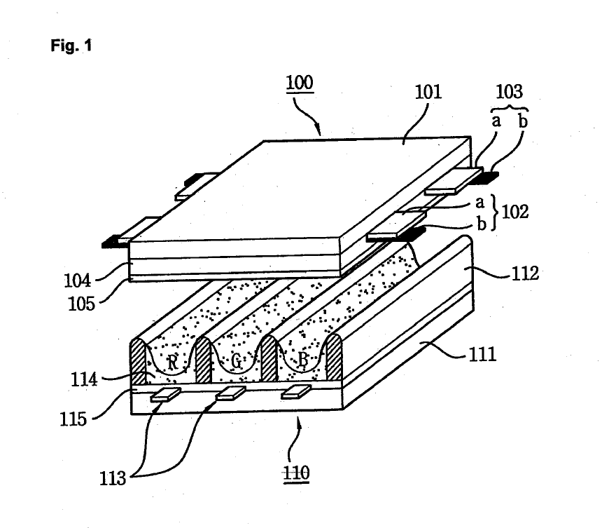

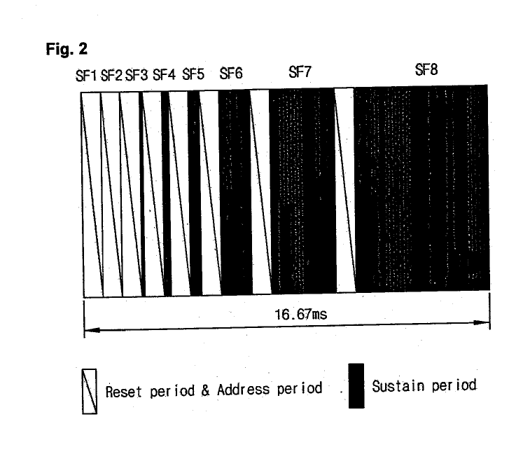

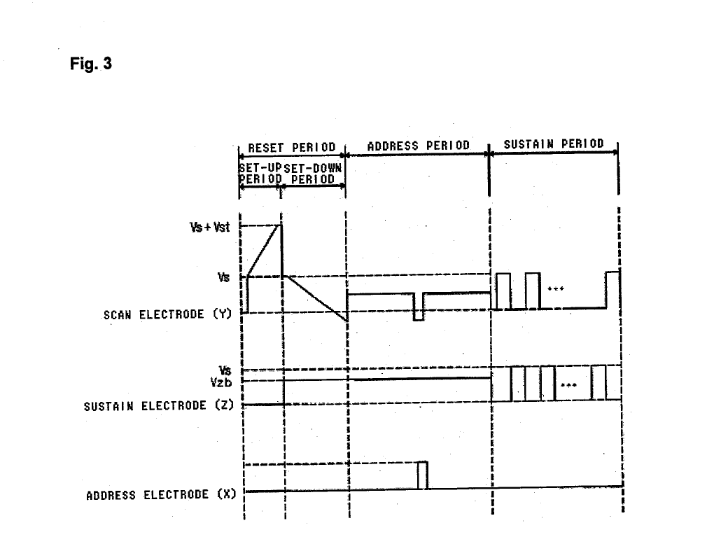

### DETAILED DESCRIPTION OF THE PREFERRED EMBODIMENT

Preferred embodiments of the present invention will be described in a more detailed manner with reference to the drawings.

A plasma display apparatus according to an aspect of the present invention comprises a plasma display panel in which images are represented with each of a plurality of sub-fields being divided into a reset period, an address period and a sustain period, a set-up controller for controlling an amplitude of a set-up pulse applied to a scan electrode during the reset period according to an APL value of an externally input image signal, and a set-up supply unit for supplying an amplitude of the controlled set-up pulse to the scan electrode.

The amplitude of the set-up pulse is controlled in proportion to the APL value of the image signal.

The amplitude of the set-up pulse is controlled in any one or more of the plurality of sub-fields.

The set-up pulse is a pulse with a slope.

The set-up controller comprises an APL calculation unit for calculating an APL of the externally input image signal, a comparator for comparing a predetermined reference voltage and a voltage set according to the APL, and a signal output unit for outputting a control signal to control the amplitude of the set-up pulse according to the comparison result value of the comparator.

The amplitude of the set-up pulse is controlled according to a control signal applied to a gate terminal of a switching element included in the set-up supply unit.

A plasma display apparatus according to another, aspect of the present invention comprises a plasma display panel in which images are represented with each of a plurality of sub-fields being divided into a reset period, an address period and a sustain period, and a set-up controller for controlling a slope of a set-up pulse applied to a scan electrode during the reset period according to an APL value of an externally input image signal.

The slope of the set-up pulse is controlled in proportion to the APL value of the image signal.

The slope of the set-up pulse is controlled in any one or more of the plurality of sub-fields.

The set-up controller comprises an APL calculation unit for calculating an APL of the externally input image signal, a comparator for comparing a predetermined reference voltage and a slope set according to the APL, and a signal output unit for outputting a control signal to control the slope of the set-up pulse according to the comparison result value of the comparator.

In a method of driving a plasma display apparatus according to further another aspect of the present invention, an amplitude of a set-up pulse applied to a scan electrode during a reset period is controlled according to an APL value of an externally input image signal.

Detailed embodiments of the present invention will now be described with reference to the accompanying drawings.

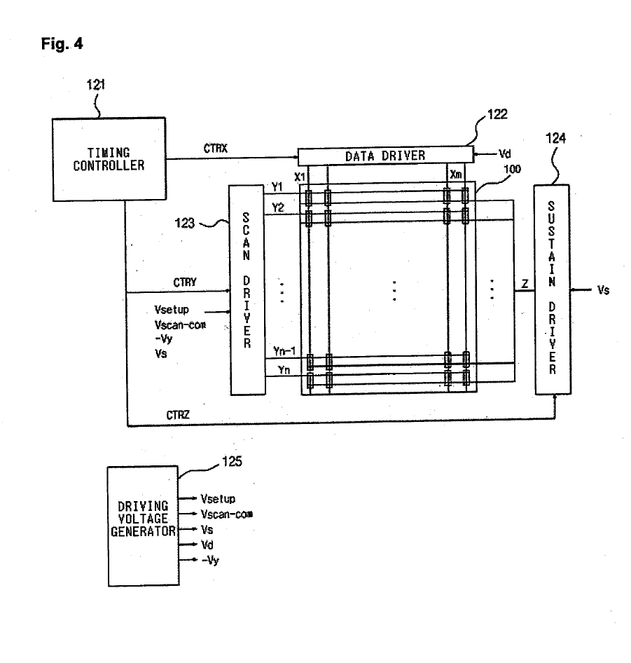

FIG. 4 is a block diagram of a plasma display apparatus according to the present invention. Referring to FIG. 4, the plasma display apparatus according to the present invention comprises a plasma display panel 100, a data driver 122 for supplying data to address electrodes X1 to Xm formed on a lower substrate (not shown) of the plasma display panel 100, a scan driver 123 for driving scan electrodes Y1 to Yn, a sustain driver 124 for driving sustain electrodes Z (i.e., a common electrode), a timing controller 121 for controlling the data driver 122, the scan driver 123 and the sustain driver 124 when the plasma display panel is driven, and a driving voltage generator 125 for supplying driving voltages necessary for the drivers 122, 123 and 124 thereto.

The plasma display panel 100 comprises an upper substrate (not shown) and a lower substrate (not shown), which are attached with a predetermined distance therebetween. A number of electrodes, such as the scan electrodes Y1 to Yn and the sustain electrodes Z, is formed in pairs in the upper substrate. The address electrodes X1 to Xm are formed to cross the scan electrodes Y1 to Yn and the sustain electrodes Z in the lower substrate.

Data supplied to data driver 122 has been inverse gamma corrected, error diffused and so on through an inverse gamma correction circuit (not shown), an error diffusion circuit (not shown) and the like and is then mapped to respective sub-fields by a sub-field mapping circuit. The data driver 122 samples and latches data in response to a timing control signal (CTRX) from the timing controller 121 and supplies the data to the address electrodes X1 to Xm.

The scan driver 123 supplies a ramp-up pulse (Ramp-up) and a ramp-down pulse (Ramp-down) to the scan electrodes Y1 to Yn under the control of the timing controller 121 during the reset period. The scan driver 123 also sequentially supplies a scan pulse (Sp) of a scan voltage (−Vy) to the scan electrodes Y1 to Yn during the address period under the control of the timing controller 121. The scan driver 123 comprises an energy recovery circuit (not shown), and supplies a sustain pulse, which rises up to a sustain voltage, to the scan electrodes Y1 to Yn during the sustain period under the control of the timing controller 121.

The sustain driver 124 comprises an energy recovery circuit (not shown) in the same manner as the scan driver 123, and supplies a sustain pulse (sus) to the sustain electrodes Z during the sustain period under the control of the timing controller 121. The energy recovery circuit in the sustain driver 124 has the same construction as the the energy recovery circuit in scan electrode driving unit 123. The energy recovery circuit in the sustain driver 124 alternately operates with the energy recovery circuit in the scan driver 123.

The timing controller 121 receives vertical/horizontal sync signals and a clock signal, generates timing control signals. (CTRX, CTRY and CTRZ) for controlling an operating timing and synchronization of the respective drivers 122, 12.3 and 124 and a sustain pulse controller 126 in the reset period, the address period and the sustain period, and provides the generated timing control signals (CTRX, CTRY, CTRZ) to corresponding-drivers 122, 123 and 124, thus controlling the respective drivers 122, 123 and 124.

The data control signal (CTRX) comprises a sampling clock for sampling data, a latch control signal, and a switching control signal for controlling an on/off time of an energy recovery circuit and a driving switch element. The scan control signal (CTRY) comprises a switching control signal for controlling an on/off time of an energy recovery circuit and a driving switch element within the scan driver 123. The sustain control signal (CTRZ) comprises a switching control signal for controlling an on/off time of an energy recovery circuit and a driving switch element within the sustain driver 124.

The driving voltage generator 125 generates a set-up voltage (Vsetup), a common scan voltage (Vscan-com), a scan voltage (−Vy), a sustain voltage (Vs), a data voltage (Vd) and the like. These driving voltages may be varied depending on the composition of a discharge gas, the structure of a discharge cell and/or the like.

In the plasma display apparatus constructed above according to the present invention, an image is displayed through a combination of a plurality of sub-fields, each being divided into a reset period, an address period and a sustain period.

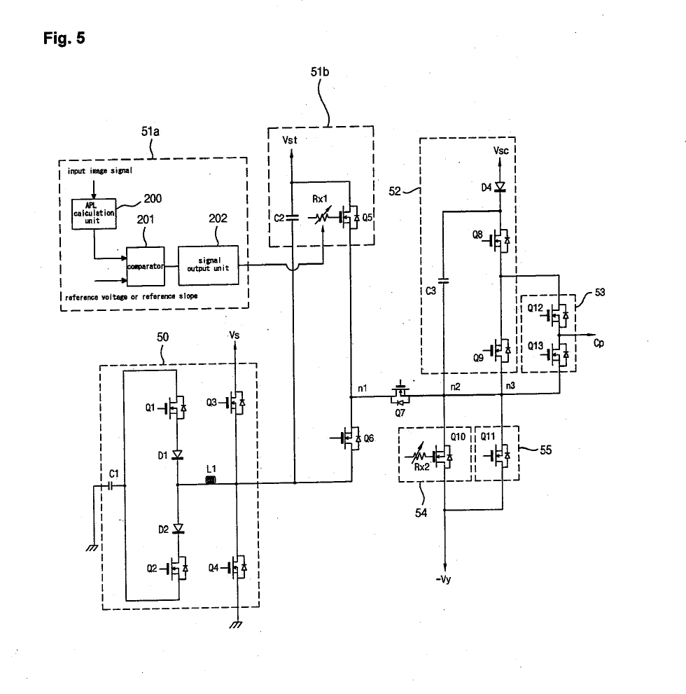

FIG. 5 is a circuit diagram illustrating the scan driver of the plasma display apparatus according to the present invention.

As shown in FIG. 5, the scan driver 123 of the plasma display panel according to the present invention comprises a driving integrated circuit unit 53, an energy recovery circuit unit 50, a scan reference voltage supply unit 52, a set-down supply unit 54, a negative scan voltage supply unit 55, a set-up controller 51a, a set-up supply unit 51b, a seventh switch Q7 connected between the set-up supply unit 51b and the driving integrated circuit unit 53, and a sixth switch Q6 connected between the set-up supply unit 51b and the energy recovery circuit unit 50.

The driving integrated circuit unit 53 includes twelfth and thirteenth switches Q12, Q13 to which voltage signals are input from the energy recovery circuit unit 50, the set-up supply unit 51b, the scan reference voltage supply unit 52, the set-down supply unit 54 and the negative scan voltage supply unit 55. The twelfth and thirteenth switches Q12, Q13 are connected in a push-pull form. Furthermore, an output line between the twelfth and thirteenth switches Q12, Q13 is connected to a panel Cp, preferably to any one of scan electrode lines of the panel Cp.

The energy recovery circuit unit 50 comprises an energy supply and recovery capacitor C1 for charging energy recovered from the panel Cp, an inductor L1 connected between the energy supply and recovery capacitor. C1 and the driving integrated circuit unit 53, a first switch Q1 connected in parallel between the inductor L1 and the energy supply and recovery capacitor C1, a first diode D1, a second switch Q2 and a second diode D2.

The scan reference voltage supply unit 52 comprises a third capacitor C3 connected between a scan voltage source (Vsc) and a second node n2, and an eighth switch Q8 and a ninth switch Q9 connected between the scan voltage source (Vsc) and the third node n3. The eighth switch Q8 and the ninth switch Q9 are switched according to a control signal output from the timing controller (not shown) during the address period, and thus supply a voltage of the scan voltage source (Vsc) to the driving integrated circuit unit 53. The third capacitor C3 sums a voltage applied to the second node n2 and a voltage value of the scan voltage source (Vsc) and supplies the result to the eighth switch Q8.

The set-down supply unit 54 comprises a tenth switch Q10 connected between the second node n2 and a negative scan voltage (−Vy). The set-down supply unit 54 causes a voltage, which is applied to the driving integrated circuit unit 53, to slowly fall up to a negative scan voltage (−Vy) with a predetermined slope during the set-down period of the reset period. [In this case, the negative scan voltage (−Vy) is used as a set-down voltage source.

The negative scan voltage supply unit 55 comprises an eleventh switch Q11 connected between the third, node n3 and the negative scan voltage source (−Vy). The eleventh switch Q11 is switched according to a control signal output from the timing controller (not shown) during the address period and supplies a negative scan voltage (−Vy) to the driving integrated circuit unit 53.

The set-up controller 51a comprises an APL calculation unit 200 for calculating an APL value of an externally input image signal, a comparator 201 for comparing a voltage or slope depending on an APL and a predetermined reference voltage value or a reference slope value, and a signal output unit 202 for outputting a signal to control an amplitude of a set-up pulse or a slope of a set-up pulse, which is supplied to the scan electrode Y, according to the comparison result of the comparator 201.

The operation of the set-up controller 51a constructed above will be described below in more detail.

The APL calculation unit 200 receives an externally input image signal, calculates an APL value and outputs the resulting value.

The comparator 201 compares a voltage value or a slope value that is set according to the APL value received from the APL calculation unit 200 and a predetermined reference voltage value or slope value that is stored in a predetermined memory, and outputs its comparison result value.

The signal output unit 202 receives the comparison result value from the comparator 201 and outputs a control signal to control an amplitude or slope of a set-up pulse supplied to the scan electrode during the reset period.

As described above, the set-up controller 51a receives an external image signal and outputs a control signal that controls an amplitude or slope of a set-up pulse that is finally supplied to the scan electrodes.

The set-up pulse can have various types of waveforms such as a square wave or a sine wave, but is, preferably, a ramp waveform having a slope.

The set-up supply unit 51b receives the control signal from the set-up controller 51a and supplies a set-up pulse that has been finally controlled to the scan electrodes.

The set-up supply unit 51b comprises a fifth switch Q5 connected between a set-up voltage source (Vst) and a first node n1, and a second capacitor C2 connected between the set-up voltage source (Vst) and the energy recovery circuit unit 50. The second capacitor C2 sums the sustain voltage (Vs) output from the energy recovery circuit unit 50 and a voltage value of the set-up voltage source (Vst) and supplies the summed result to the fifth switch Q5. The fifth switch Q5 is switched in response to the control signal of the set-up controller 51a during the reset period, and supplies a set-up pulse voltage having a variable amplitude or slope to the first node n1.

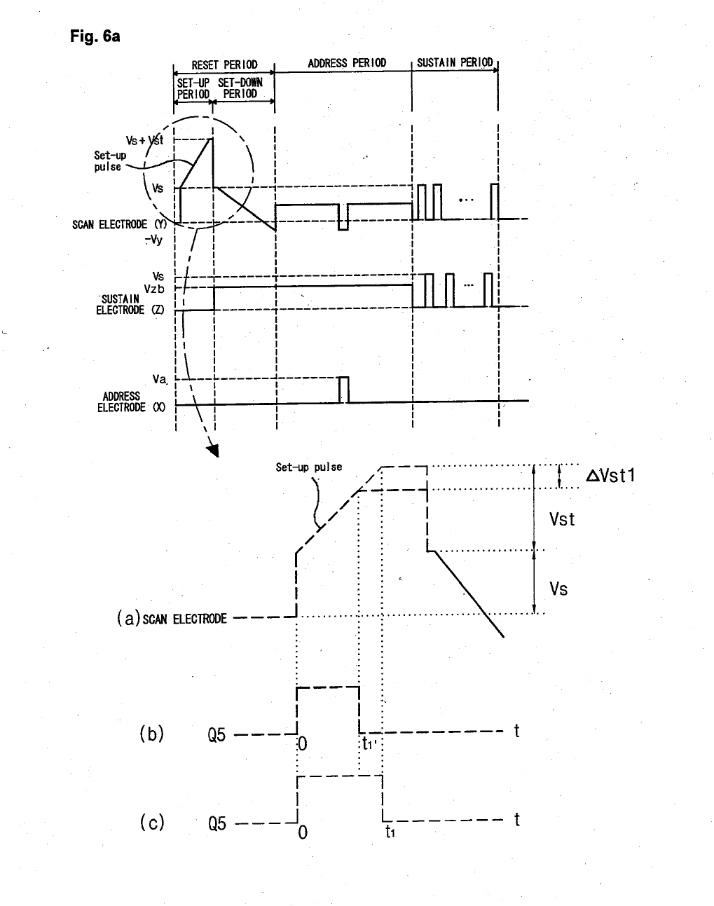

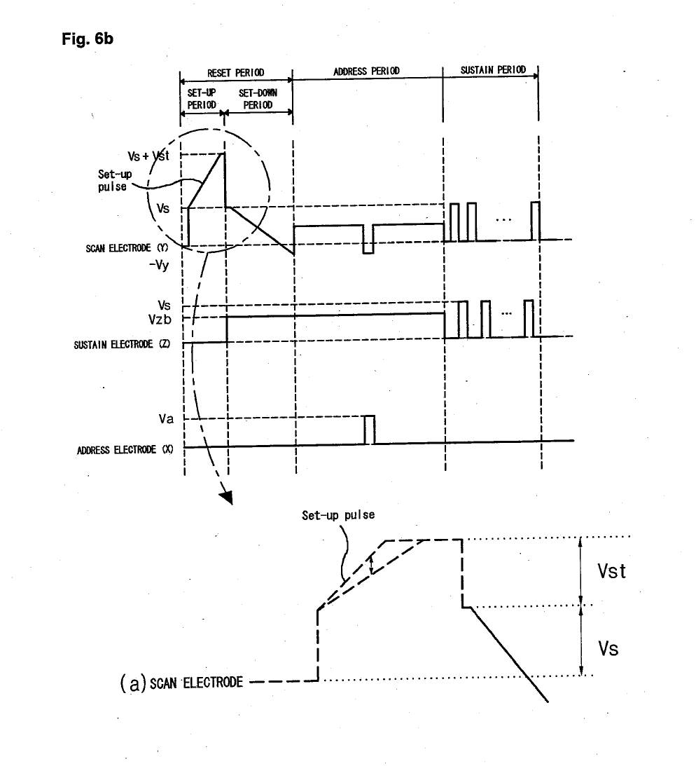

FIGS. 6a and 6b illustrate a set-up pulse supplied during the reset period by means of the scan driver of the plasma display apparatus according to the present invention.

FIG. 6a shows that an amplitude of a set-up pulse is controlled according to an APL value. FIG. 6b shows that the slope of a set-up pulse is controlled according to an APL value. This will now be described in connection with FIG. 5.

In FIG. 6a, (a) shows an amplitude of a set-up pulse applied to the scan electrode (Y electrode) of the plasma display panel during the reset period, i.e., a set-up voltage.

In FIG. 6a, (b) shows a timing of a pulse applied to the gate terminal of the fifth switch Q5 when an APL value of an externally input image signal is low according to the present invention.

In FIG. 6a, (c) shows a timing of a pulse applied to the gate terminal of the fifth switch Q5 when an APL value of an externally input image signal is high according to the present invention.

In the plasma display apparatus of the present invention, when the APL value of the externally input image signal is low, a pulse having a short on-time (t1′) is applied to the gate terminal of the fifth switch Q5, as shown in (b). Therefore, a low voltage (Vs+Vst−ΔVst1) can be applied to the scan electrode Y corresponding to the APL value of the externally input image signal as shown in (a).

When the APL value of the externally input image signal is high, a pulse having a long on-time (t1) is applied to the gate terminal of the fifth switch Q5, as shown in (c). Therefore, a high voltage (Vs+Vst) can be applied to the scan electrode Y corresponding to the APL value of the externally input image signal.

As described above, an amplitude of a set-up pulse applied to the scan electrode Y is controlled in proportion to an APL value of an externally input image signal.

The amplitude of the set-up pulse applied to the scan electrode Y is controlled in any one of a plurality of sub-fields.

In FIG. 6a, (a) shows the slope of a set-up pulse applied to the scan electrode Y of the plasma display panel during the reset period.

As shown in (a) of FIG. 6b, in the plasma display apparatus of the present invention, when the APL value of the externally input image signal is low, the signal output unit 202 of FIG. 5 outputs a control signal that sets the slope of the set-up pulse to be small. The control signal controls a resistance value of a variable resistor disposed at the front of the gate terminal of the fifth switch Q5 of the set-up supply unit 51b so that the set-up supply unit applies a set-up pulse of a small slope to the scan electrode.

When the APL value of the externally input image signal is high, the signal output unit 202 of FIG. 5 outputs a control signal that controls the slope of the set-up pulse to be great. The control signal controls a resistance value of the variable resistor disposed at the front of the gate terminal of the fifth switch Q5 of the set-up supply unit 51b so that the set-up supply unit applies a set-up pulse of a great slope to the scan electrode.

That is, the slope of the set-up pulse applied to the scan electrode Y is controlled in proportion to an APL value of an externally input image signal.

The slope of the set-up pulse applied to the scan electrode Y is also controlled in any one of a plurality of sub-fields.

As described above in detail, in accordance with the present invention, an amplitude or slope of a reset pulse voltage is variably controlled according to an externally input image signal. Therefore, not only a contrast ratio characteristic of a plasma display panel can be improved, but also address driving margins improved. It is thus possible to enhance driving efficiency of a plasma display panel.

The invention being thus described may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel in which images are represented with each of a plurality of sub-fields being divided into a reset period, an address period and a sustain period;
a set-up controller for controlling an amplitude of a set-up pulse applied to a scan electrode during the reset period according to an APL value of an externally input image signal; and
a set-up supply unit for supplying an amplitude of the controlled set-up pulse to the scan electrode.

2. The plasma display apparatus as claimed in claim 1, wherein the amplitude of the set-up pulse is controlled in proportion to the APL value of the image signal.

3. The plasma display apparatus as claimed in claim 1, wherein the amplitude of the set-up pulse is controlled in any one or more of the plurality of sub-fields.

4. The plasma display apparatus as claimed in claim 1, wherein the set-up pulse is a pulse with a slope.

5. The plasma display apparatus as claimed in claim 1, wherein the set-up controller comprises:
an APL calculation unit for calculating an APL of the externally input image signal;
a comparator for comparing a predetermined reference voltage and a voltage set according to the APL; and
a signal output unit for outputting a control signal to control the amplitude of the set-up pulse according to the comparison result value of the comparator.

6. The plasma display apparatus as claimed in claim 1, wherein the amplitude of the set-up pulse is controlled according to a control signal applied to a gate terminal of a switching element included in the set-up supply unit.

7. A plasma display apparatus comprising:
a plasma display panel in which images are represented with each of a plurality of sub-fields being divided into a reset period, an address period and a sustain period; and
a set-up controller for controlling a slope of a set-up pulse applied to a scan electrode during the reset period according to an APL value of an externally input image signal.

8. The plasma display apparatus as claimed in claim 7, wherein the slope of the set-up pulse is controlled in proportion to the APL value of the image signal.

9. The plasma display apparatus as claimed in claim 7, wherein the slope of the set-up pulse is controlled in any one or more of the plurality of sub-fields.

10. The plasma display apparatus as claimed in claim 7, wherein the set-up controller comprises:
an APL calculation unit for calculating an APL of the externally input image signal;
a comparator for comparing a predetermined reference voltage and a slope set according to the APL; and
a signal output unit for outputting a control signal to control the slope of the set-up pulse according to the comparison result value of the comparator.

11. A method of driving a plasma display apparatus that is driven with each of a plurality of sub-fields being divided into a reset period, an address period and a sustain period,
wherein an amplitude of a set-up pulse applied to a scan electrode during the reset period is controlled according to an APL value of an externally input image signal.

12. The method as claimed in claim 11, wherein the amplitude of the set-up pulse is controlled in proportion to the APL value of the image signal.

13. The method as claimed in claim 11, wherein the amplitude of the set-up pulse is controlled in any one or more of the plurality of sub-fields.

14. The method as claimed in claim 11, wherein the set-up pulse is a pulse having a slope.

15. The method as claimed in claim 11, wherein the amplitude of the set-up pulse is controlled according to the steps of:
calculating an APL of the externally input image signal;
comparing a predetermined reference voltage and a voltage set according to the APL; and
outputting a control signal to control the amplitude of reset pulse according to the comparison result value.
